(19) United States
(12) Patent Application Publication
(10) Pub. No.: US 2020/0372798 A1
(43) Pub. Date: Nov. 26, 2020

(54) ELECTRONIC DEVICE AND METHOD FOR DETECTING PARKING OCCUPANCY

(71) Applicant: NANNING FUGUI PRECISION INDUSTRIAL CO., LTD., Nanning (CN)

(72) Inventor: TSUNG-CHIEH HSU, New Taipei (TW)

(21) Appl. No.: 16/552,217

(22) Filed: Aug. 27, 2019

(30) Foreign Application Priority Data
May 23, 2019 (CN) 201910436133.6

(51) Int. Cl. G08G 1/14; G08G 1/042; H04L 29/08; H04W 52/02; H04W 64/00

(52) U.S. Cl. CPC G08G 1/144; G08G 1/042; H04W 64/003; H04W 52/0229; H04L 67/12

(57) ABSTRACT

A method for detecting occupancy or non-occupancy of a parking space applied in an electronic device includes using a magnetic sensor to detect occupancy or non-occupancy of a parking space; controlling, when the magnetic sensor detects that a vehicle enters or leaves the parking space, an IoT device of the electronic device to be awoken and controlled to search for a cell base on an IoT protocol, and parameter values of the searching signal are analyzed. Characteristics of the searching signal are valued and compared to predetermined standard values. A determination that the parking space is occupied or not occupied is made when, respectively, the value of each measured characteristic is greater than, or is less than or equal to the corresponding predetermined standard value of each characteristic.

### CROSS-REFERENCE TO RELATED APPLICATIONS

This application claims priority to Chinese Patent Application No. 201910436133.6 filed on May 23, 2019, the contents of which are incorporated by reference herein.

### FIELD

The subject matter herein generally relates to Internet of Things (IoT) technology, and particularly to an electronic device and a method for detecting parking occupancy.

### BACKGROUND

Smart parking systems based on magnetic devices are widely used. The magnetic device, arranged on each parking space, detects whether the parking space is occupied and sends parking information to at least one user terminal, such as a mobile phone. However, magnetic field detected by magnetic sensors of the magnetic device can be easily affected by parked vehicles in other nearby parking spaces, thus the parking information may be inaccurate, so that the user may receive wrong information.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an application environment of an electronic device for detecting parking occupancy.

FIG. 2 is a block diagram of an embodiment of the electronic device of FIG. 1.

FIG. 3 is a block diagram of an embodiment of a parking occupancy detecting system.

FIG. 4 illustrates a flowchart of an embodiment of a method for detecting parking occupancy.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

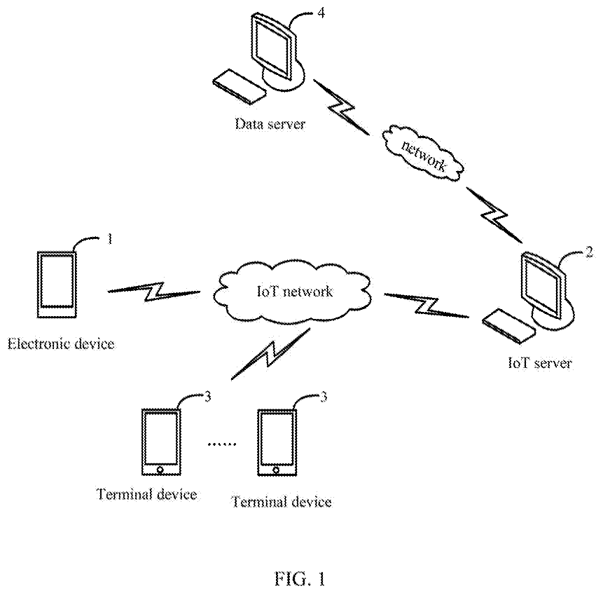

FIG. 1 illustrates an embodiment of an application environment of an electronic device 1 for detecting parking occupancy. The electronic device 1 can communicate with an IoT (Internet of Things) server 2 through a network. In at least one embodiment, the network can be an IoT network based on LwM2M (Lightweight Machine to Machine) protocol.

In at least one embodiment, the electronic device 1 can further communicate with at least one terminal device 3. The terminal device 3 can be a smart phone or a personal computer.

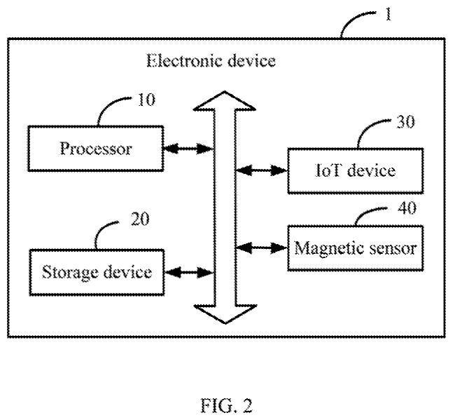

Referring to FIG. 2, the electronic device 1 includes, but is not limited to, a processor 10, a storage device 20, an IoT device 30, and a magnetic sensor 40. The electronic device 1 further runs a parking occupancy detecting system 100. FIG. 2 illustrates only one example of the electronic device 1, other examples can include more or fewer components than illustrated, or can have a different configuration of the various components in other embodiments.

The processor 10 can be a central processing unit (CPU), a microprocessor, or other data processor chip that performs functions of the electronic device 1.

In at least one embodiment, the storage device 20 can include various types of non-transitory computer-readable storage mediums. For example, the storage device 20 can be an internal storage system, such as a flash memory, a random access memory (RAM) for temporary storage of information, and/or a read-only memory (ROM) for permanent storage of information. The storage device 20 can also be an external storage system, such as a hard disk, a storage card, or a data storage medium.

In at least one embodiment, the IoT device 30 can be a communication device base on an IoT protocol. The magnetic sensor 40 is arranged in or on ground corresponding to a parking space, and can communicate with the IoT device 30 through wireless network, such as BLUETOOTH, WI-FI, or ZIGBEE.

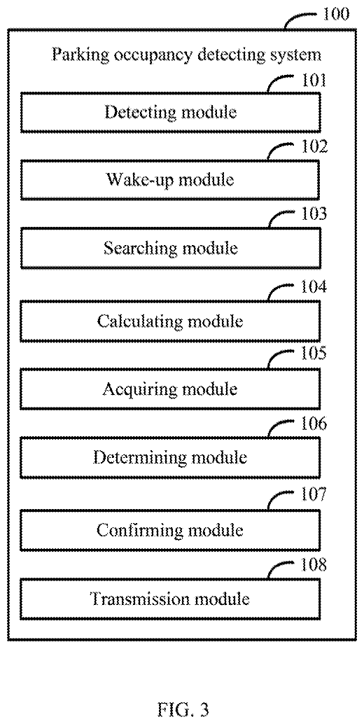

Referring to FIG. 3, the parking occupancy detecting system 100 at least includes a detecting module 101, a wake-up module 102, a searching module 103, a calculating module 104, an acquiring module 105, a determining module 106, a confirming module 107, and a transmission module 108. The modules 101-108 can be collections of software instructions stored in the storage device 20 of the electronic device 1 and executed by the processor 10. The modules 101-108 also can include functionality represented as hardware or integrated circuits, or as software and hardware combinations, such as a special-purpose processor or a general-purpose processor with special-purpose firmware.

The detecting module 101 is used to control the magnetic sensor 40 to detect occupancy or non-occupancy of a parking space.

In at least one embodiment, the detecting module 101 controls the magnetic sensor 40 to detect the occupancy or non-occupancy of the parking space at predetermined time intervals. The magnetic sensor 40 carries out the detection according to a change of magnetic field intensity around the parking space. In at least one embodiment, the predetermined time interval can be ten minutes.

When the magnetic sensor 40 detects that a vehicle leaves the parking space, the magnetic sensor 40 determines that the parking space is not occupied. When the magnetic sensor 40 detects that a vehicle is parking in the parking space, the magnetic sensor 40 determines that the parking space is occupied.

When the magnetic sensor 40 detects that the parking space is occupied or not occupied, the wake-up module 102 is used to wake up the IoT device 30 from a power-saving mode, to enter a connection mode.

In at least one embodiment, working modes of the IoT device 30 include the connection mode and the power-saving mode. In detail, in an initial state, no vehicle is parked in the parking space, the IoT device 30 is idle, and the IoT device 30 can automatically sleep to enter the power-saving mode. When a vehicle is parked in the parking space or a vehicle leaves the parking space, the IoT device 30 is woken up from the power-saving mode to enter the connection mode, and attempts to communicate with the IoT server 2. The occupancy or non-occupancy of the parking space can thus be transmitted to the terminal device 3 through the IoT server 2 in time.

The searching module 103 is used to control the IoT device 30 to search for a cell base on the IoT protocol.

In at least one embodiment, when the IoT device 30 is awakened and attempts to communicate with the IoT server 2, the IoT device 30 requires to search for the cell to achieve synchronization with a time of the cell and a frequency of the cell, so as to read system information and carry out subsequent data transmission. In at least one embodiment, the system information at least includes a cell ID, a system bandwidth, and cell broadcast information.

The calculating module 104 is used to calculate a number of parameter values of received signal when the IoT device 30 is searching for the cell.

In at least one embodiment, the IoT server 2 transmits IoT signals, when the IoT device 30 is searching for the cell to attempts to communicate with the IoT server 2, and the IoT device 30 can receive the IoT signals from the IoT server 2. The number of parameter values at least include a received signal strength value Sᵣₓₗₑᵥ, a received signal level value Qᵣₑₗₑᵥₘₑₐₛ, and a minimum threshold value Qᵣₓₗₑᵥₘᵢₙ of the received signal.

The calculating module 104 calculates the received signal strength value Sᵣₓₗₑᵥ using following equation 1:

Sᵣₓₗₑᵥ=Qᵣₓₗₑᵥₘₑₐₛ−(Qᵣₓₗₑᵥₘᵢₙ+Q_{rxlevminoffset})−P_{compensation} (1).

In equation 1, Q_{rxlevminoffset} is an offset value of the minimum threshold value Qᵣₓₗₑᵥₘᵢₙ, when the IoT device 30 resides on a VPLMN (Visited Public Land Mobile Network) for periodically searching PLMN (Public Land Mobile Network) with a higher level, P_{compensation} is equal to max (PEMAX-PUMAX, 0), therein PEMAX is a maximum permitted transmitting power determined by the system when the IoT device 30 enters the searched cell, and PUMAX is a maximum output power of the IoT device 30. The received signal level value Qᵣₑₗₑᵥₘₑₐₛ and the minimum threshold value Qᵣₓₗₑᵥₘᵢₙ of the received signal can be acquired on a RF log generated by the IoT device 30 when the cell is being searched for.

The acquiring module 105 is used to acquire a predetermined standard value corresponding to each of number of parameter values of the received signal from the IoT server 2.

In at least one embodiment, when the IoT device 30 communicates with the IoT server 2 through searching for the cell, the acquiring module 105 can download the predetermined standard value corresponding to each parameter value from the IoT server 2.

For example, a predetermined standard value corresponding to the received signal strength value Sᵣₓₗₑᵥ can be V1, a predetermined standard value corresponding to the received signal level value Qᵣₓₗₑᵥₘₑₐₛ can be V2, a predetermined standard value corresponding to the minimum threshold value of the received signal Qᵣₓₗₑᵥₘᵢₙ can be V3, and a time value or count can be T.

The determining module 106 is used to determine whether each of the number of parameter values is greater than the predetermined standard value.

In at least one embodiment, the determining module 106 determines whether each of the number of parameter values is greater than the predetermined standard value within a predetermined time interval T.

In detail, the determining module 106 determines, within the predetermined time interval T, whether the received signal strength value Sᵣₓₗₑᵥ is greater than the predetermined standard value V1, whether the received signal level value Qᵣₓₗₑᵥₘₑₐₛ is greater than the predetermined standard value V2, and whether the minimum threshold value of the received signal Qᵣₓₗₑᵥₘᵢₙ is greater than the predetermined standard value V3.

The confirming module 107 is used to confirm that a vehicle is parked in the parking space and that the parking space is occupied, when each of the number of parameter values of the received signal is greater than the predetermined standard value.

In other embodiments, when at least one of the number of parameter values of the received signal is greater than the predetermined standard value, the confirming module 107 can confirm that a vehicle is parked in the parking space and that the parking space is occupied.

The confirming module 107 is further used to confirm that a vehicle leaves the parking space and that the parking space is not occupied, when each of the number of parameter values of the received signal is equal to or less than the predetermined standard value.

In other embodiments, when at least one of the number of parameter values of the received signal is equal to or less than the corresponding predetermined standard value, the confirming module 107 can confirm that a vehicle leaves the parking space and that the parking space is not occupied.

The transmission module 108 is used to transmit information as to a state of the parking space to the terminal device 3.

In at least one embodiment, the information as to a state of the parking space includes an occupied or a non-occupied state.

The calculating module 104 can further upload the number of calculated parameter values of the received signal to the IoT server 2, the IoT server 2 can transmit the number of calculated parameter values of the received signal to a data server 4 (shown in FIG. 1). The data server 4 can calculate updated predetermined standard values, and transmit the updated predetermined standard values back to the IoT server 2.

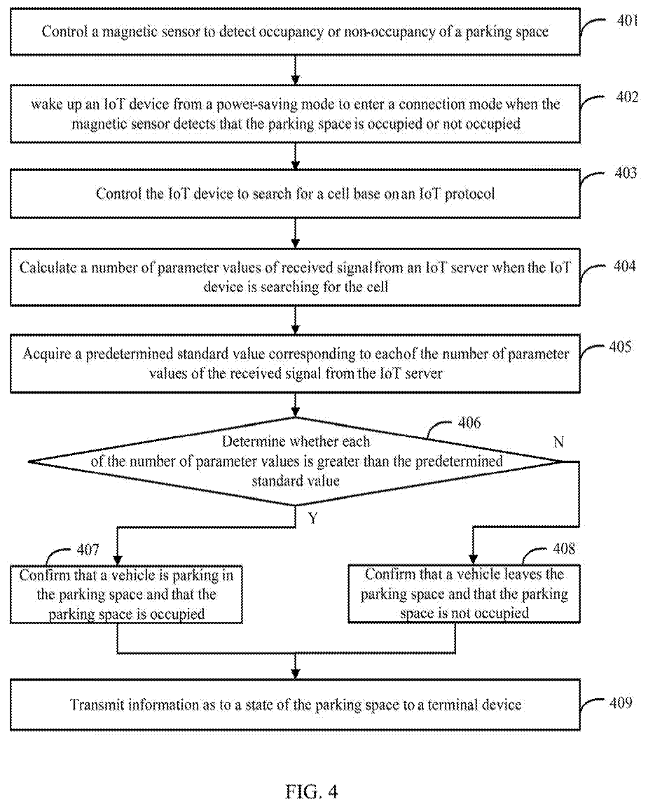

FIG. 4 illustrates a flowchart of an embodiment of a method for detecting parking occupancy. The method is provided by way of example, as there are a variety of ways to carry out the method. The method described below can be carried out using the configurations illustrated in FIG. 1-3, for example, and various elements of these figures are referenced in explaining the example method. Each block shown in FIG. 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 401.

At block 401, a detecting module controls a magnetic sensor of an electronic device to detect occupancy or non-occupancy of a parking space.

At block 402, when the magnetic sensor detects that the parking space is occupied or not occupied, a wake-up module wakes up an IoT device of the electronic device from a power-saving mode to enter a connection mode.

At block 403, a searching module controls the IoT device to search for a cell base on the IoT protocol.

At block 404, a calculating module calculates a number of parameter values of received signal from an IoT server when the IoT device is searching for the cell.

At block 405, an acquiring module acquires a predetermined standard value corresponding to each of the number of parameter values of the received signal from the IoT server.

At block 406, a determining module determines whether each of the number of parameter values is greater than the predetermined standard value.

At block 407, a confirming module confirms that a vehicle is parking in the parking space and that the parking space is occupied, when each of the number of parameter values of the received signal is greater than the predetermined standard value.

At block 408, the confirming module further confirms that a vehicle leaves the parking space and that the parking space is not occupied, when each of the number of parameter values of the received signal is equal to or less than the predetermined standard value.

At block 409, a transmission module transmits information as to a state of the parking space to a terminal device.

The method for detecting parking occupancy can further includes: the calculating module further uploads the number of calculated parameter values of the received signal to the IoT server, the IoT server transmits the number of calculated parameter values of the received signal to a data server, the data server 4 calculates updated predetermined standard values, and transmit the updated predetermined standard values back to the IoT server.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

1. A method for detecting parking occupancy applicable in an electronic device comprising:
controlling a magnetic sensor of the electronic device to detect occupancy or non-occupancy of a parking space;
controlling, when the magnetic sensor detects that the parking space is occupied, an Internet of Things (IoT) device of the electronic device to search for a cell base on an IoT protocol;
calculating a plurality of parameter values of received signal from an IoT server when the IoT device is searching for the cell;
determining whether each of the plurality of parameter values is greater than a predetermined standard value; and
confirming, when each of the plurality of parameter values of the received signal is greater than the predetermined standard value, that the parking space is occupied.

2. The method according to claim 1, further comprising:
controlling, when the magnetic sensor detects that the parking space is not occupied, the IoT device to search for the cell based on the IoT protocol;
calculating a plurality of parameter values of received signal from the IoT server when the IoT device is searching for the cell;
determining whether each of the plurality of parameter values is equal to or less than the predetermined standard value; and
confirming, when each of the plurality of parameter values of the received signal is equal to or less than the predetermined standard value, that the parking space is not occupied.

3. The method according to claim 2, further comprising:
acquiring a predetermined standard value corresponding to each of the plurality of parameter values of the received signal from the IoT server.

4. The method according to claim 2, further comprising:
uploading the plurality of parameter values of the received signal to the IoT server, wherein the IoT server transmits the plurality of calculated parameter values of the received signal to a data server, the data server calculates updated predetermined standard values, and transmits the updated predetermined standard values back to the IoT server.

5. The method according to claim 2, further comprising:
waking up the IoT device from a power-saving mode to enter a connection mode when the magnetic sensor detects that the parking space is occupied or not occupied;
controlling the IoT device to search for the cell base on the IoT protocol when the IoT device enters the connection mode.

6. The method according to claim 1, wherein the plurality of parameter values comprise a received signal strength value, a received signal level value, and a minimum threshold value of the received signal.

7. The method according to claim 1, wherein the magnetic sensor detects the occupancy or non-occupancy of the parking space according to a change of magnetic field intensity of the parking space.

8. The method according to claim 1, wherein the magnetic sensor communicates with the IoT device through a wireless network, and the IoT device communicates with the IoT server through the IoT protocol.

9. An electronic device comprising:
at least one processor;
a magnetic sensor coupled to the at least one processor;
an IoT device coupled to the at least one processor; and
a storage device coupled to the at least one processor and storing instructions for execution by the at least one processor to cause the at least one processor to:
control the magnetic sensor to detect occupancy or non-occupancy of a parking space;
control, when the magnetic sensor detects that the parking space is occupied, the IoT device to search for a cell base on an IoT protocol;
calculate a plurality of parameter values of received signal from an IoT server when the IoT device is searching for the cell;
determine whether each of the plurality of parameter values is greater than the predetermined standard value; and
confirm, when each of the plurality of parameter values of the received signal is greater than the predetermined standard value, that the parking space is occupied.

10. The electronic device according to claim 9, wherein the at least one processor is further caused to:
control, when the magnetic sensor detects that the parking space is not occupied, the IoT device to search for the cell based on the IoT protocol;
calculate the plurality of parameter values of received signal from the IoT server when the IoT device is searching for the cell;
determine whether each of the plurality of parameter values is equal to or less than the predetermined standard value; and
confirm, when each of the plurality of parameter values of the received signal is equal to or less than the predetermined standard value, that the parking space is not occupied.

11. The electronic device according to claim 10, wherein the at least one processor is further caused to:
acquire a predetermined standard value corresponding to each of the plurality of parameter values of the received signal from the IoT server.

12. The electronic device according to claim 10, wherein the at least one processor is further caused to:
upload the plurality of parameter values of the received signal to the IoT server, wherein the IoT server transmits the plurality of calculated parameter values of the received signal to a data server, the data server calculates updated predetermined standard values, and transmits the updated predetermined standard values back to the IoT server.

13. The electronic device according to claim 10, wherein the at least one processor is further caused to:
wake up the IoT device from a power-saving mode to enter a connection mode when the magnetic sensor detects that the parking space is occupied or not occupied;
control the IoT device to search for the cell base on the IoT protocol when the IoT device enters the connection mode.

14. The electronic device according to claim 9, wherein the plurality of parameter values comprise a received signal strength value, a received signal level value, and a minimum threshold value of the received signal.

15. The electronic device according to claim 9, wherein the magnetic sensor detects the occupancy or non-occupancy of the parking space according to a change of magnetic field intensity of the parking space.

16. The electronic device according to claim 9, wherein the magnetic sensor communicates with the IoT device through a wireless network, and the IoT device communicates with the IoT server through the IoT protocol.
